(19) United States
(12) Patent Application Publication
(10) Pub. No.: US 2026/0108415 A1
(43) Pub. Date: Apr. 23, 2026

(54) MASSAGE MACHINE

(71) Applicant: FUJI MEDICAL INSTRUMENTS MFG. CO., LTD., Osaka (JP)

(72) Inventors: Takeshi FURUTANI, Osaka (JP); Jumpei YOKOYAMA, Osaka (JP)

(73) Assignee: FUJI MEDICAL INSTRUMENTS MFG. CO., LTD., Osaka (JP)

(21) Appl. No.: 19/301,034

(22) Filed: Aug. 15, 2025

(30) Foreign Application Priority Data
Oct. 17, 2024 (JP) 2024-181468

(51) Int. Cl. A61H 15/00; A61H 9/00

(52) U.S. Cl. CPC A61H 15/0078; A61H 9/0078; A61H 2015/0014; A61H 2015/0042; A61H 2201/0149; A61H 2201/1238; A61H 2201/1623; A61H 2201/1635; A61H 2201/1676; A61H 2203/0437; A61H 2205/06

(57) ABSTRACT

Provided is a massage machine including: a base; a backrest supported by the base so as to be reclinable; a seat that moves forward relative to the base with the reclining of the backrest; an armrest; and a support mechanism for supporting the armrest so as to allow the armrest to move with the reclining of the backrest, the support mechanism being configured to lower a back end portion of the armrest and move a front end portion of the armrest backward relative to the seat when the backrest is reclined.

### CROSS-REFERENCE TO RELATED APPLICATION

This application claims priority to Japanese Patent Application No. 2024-181468, filed on Oct. 17, 2024, which is incorporated by reference in its entirely.

### FIELD

The present disclosure relates to a chair-type massage machine including a seat and a reclinable backrest.

### BACKGROUND

Conventionally, a chair-type massage machine equipped with armrests has been known (see JP 2003-310683 A).

In this massage machine, guide rails for guiding the armrests are disposed below the armrests, and the armrests move along the guide rails with the reclining of the backrest. Thereby, even if the backrest in the massage machine is reclined, the armrests move with the reclining of the backrest, so that the positional relationship between the armrests and the arms of a user does not change significantly due to the change in the posture of the user.

However, in the above-mentioned massage machine, in order to allow the armrests to move with the reclining of the backrest, many parts and the like must be arranged around the guide rails, making the configuration complicated.

### SUMMARY

An object of the present disclosure is to provide a massage machine that can allow the armrests to move with the reclining of the backrest by a simple configuration.

The following presents a simplified summary of the disclosure disclosed herein in order to provide a basic understanding of some aspects of the disclosure. This summary is not an extensive overview of the disclosure. It is intended to neither identify key or critical elements of the disclosure nor delineate the scope of the disclosure. Its sole purpose is to present some basic concepts of the disclosure in a simplified form as a prelude to the more detailed description that is presented later.

There is provided a massage machine including: a base; a backrest supported by the base so as to be reclined relative to the base; a seat that moves forward relative to the base with the reclining of the backrest; an armrest; and a support mechanism that supports the armrest so as to allow the armrest to move with the reclining of the backrest, the support mechanism being configured to lower a back end portion of the armrest and move a front end portion of the armrest backward relative to the seat when the backrest is reclined.

### BRIEF DESCRIPTION OF DRAWINGS

The foregoing and other features of the present disclosure will become apparent from the following detailed description and drawings of an illustrated embodiment of the present disclosure.

FIG. 1 is a right side view of a massage machine according to an embodiment (with exterior members and a treatment part of a backrest removed, the same applies hereinafter), with the backrest in a standing state.

FIG. 2 is a plan view of the massage machine, showing a state in which the backrest is in the standing state.

FIG. 3 is a right side view of the massage machine, showing a state in which the backrest is in a reclining state.

FIG. 4 is a partially enlarged perspective view for explaining the configuration of an armrest part and its surroundings with an armrest body removed.

FIG. 5 is a diagram for explaining the movements of the seat and the armrest.

### DETAILED DESCRIPTION OF THE PREFERRED EMBODIMENT

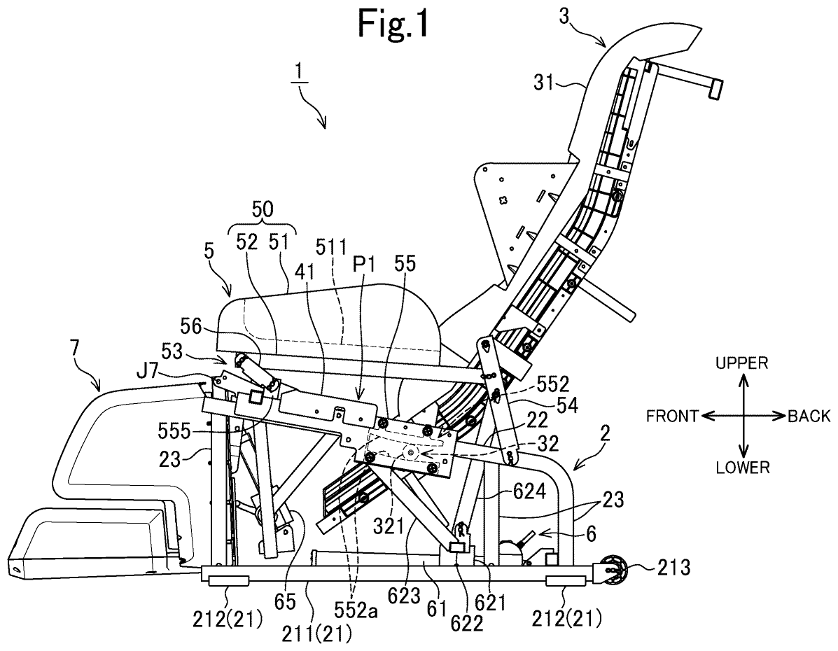

Now, a massage machine according to an embodiment of the present disclosure will be described with reference to FIG. 1 to FIG. 5. In the following description, the front and back direction, the left and right direction, and the vertical direction are the front and back direction, the right and left direction, and the vertical direction with respect to the user when the user is seated on the massage machine in a normal posture.

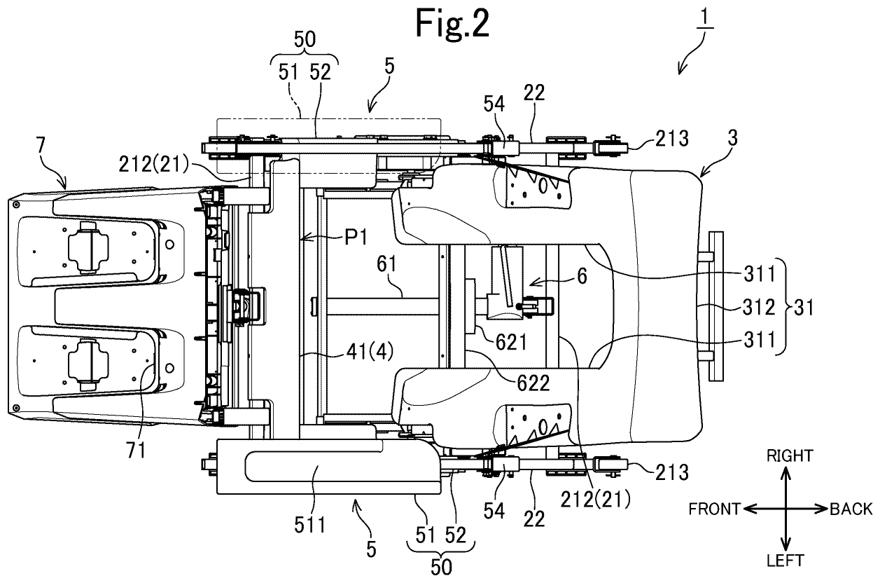

As shown in FIG. 1 to FIG. 3, the massage machine 1 of this embodiment is a chair-type massage machine (massage chair). This massage machine 1 includes a base 2 disposed on an installation surface (such as a floor surface of the installation site), a backrest 3 supported by the base 2 so as to be reclined relative to the base 2, a seat 4 that moves forward relative to the base 2 with the reclining of the backrest 3, a treatment part which is a unit provided with a treatment element, and a pair of armrest parts 5 disposed respectively on both the left and right sides of the seat 4. The massage machine 1 also includes a drive part 6 that drives the components. The massage machine 1 of this embodiment also includes an ottoman 7 connected to a front end portion of the seat 4. In each of the Figures, exterior members such as a cover and the treatment part are not shown, while an internal mechanism (excluding the treatment part) is shown. In FIG. 2, in order to make the configuration easier to see, a part of the configuration of the right armrest part 5 (armrest body 51) is shown by a two-dot chain line to allow the configuration below to be visible.

The base 2 includes a lower frame 21 that is close to or in contact with the installation surface, an upper frame 22 that supports the backrest 3 and the seat 4, and vertical connecting frames 23 that connect the lower frame 21 and the upper frame 22 to each other.

The lower frame 21 is a frame that is disposed parallel to the installation surface to be close to or in contact with the installation surface. The lower frame 21 is a square frame-shaped part in a plan or bottom view that is made up of a pair of first parts 211 extending in the front and back direction and a pair of second parts 212 extending in the left and right direction.

The pair of first parts 211 of this lower frame 21 extend in the front and back direction and are disposed at positions that do not overlap with the backrest 3 in a plan view or bottom view (in other words, at positions on both the left and right sides of the backrest 3).

The lower frame 21 has wheels 213 at the back end for use in moving the massage machine 1. The wheels 213 are disposed at the back ends of the first parts 211 and come into contact with the installation surface only when in use.

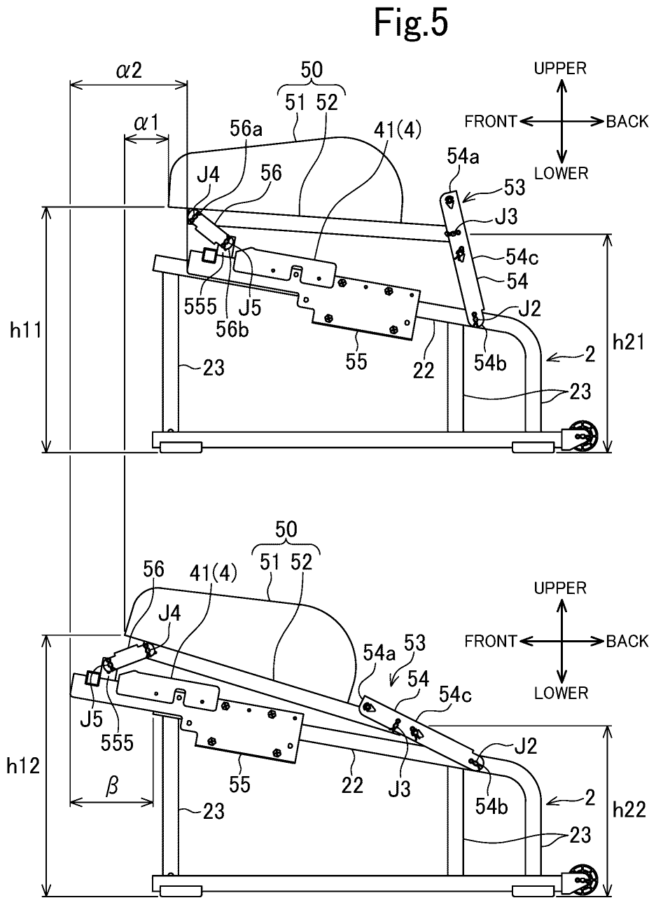

The upper frame 22 is a frame disposed above the lower frame 21 and extends in the front and back direction. The upper frame 22 is inclined to allow the front side to be positioned upward relative to the horizontal direction. Specifically, the upper frame 22 is disposed so as to overlap the first part 211 of the lower frame 21 in a plan view or a bottom view. That is, a pair of upper frames 22 are disposed respectively on the right side and the left side. The upper frame 22 is provided at a position such that its front portion is higher than its back portion relative to the installation surface and the first part 211 of the lower frame 21, and is inclined upward at a certain angle toward the front. A moving part 55 is disposed on the upper frame 22 and is capable of sliding (moving) back and forth (reciprocating) along the upper frame 22 (see FIG. 5).

The vertical connecting frames 23 are frames that extend in the vertical direction so as to connect the first part 211 of the lower frame 21 and the upper frame 22. In this embodiment, the vertical connecting frames 23 are arranged in such a manner that one frame is disposed on the front side and two frames are disposed on the back side relative to the lower frame 21 and the upper frame 22.

The vertical connecting frame 23 on the front side and the front one of the vertical connecting frames 23 on the back side extend in the vertical direction. For example, the vertical connecting frame 23 on the front side and the front one of the vertical connecting frames 23 on the back side extend straight in the vertical direction. A lower portion of the back one of the vertical connecting frames 23 on the back side extends straight, and an upper portion thereof is curved to conform to the inclination of the upper frame 22.

The lower frame 21, the upper frame 22, and the vertical frames 23 configured as described above are combined together to form the base 2 having a three-dimensional frame shape.

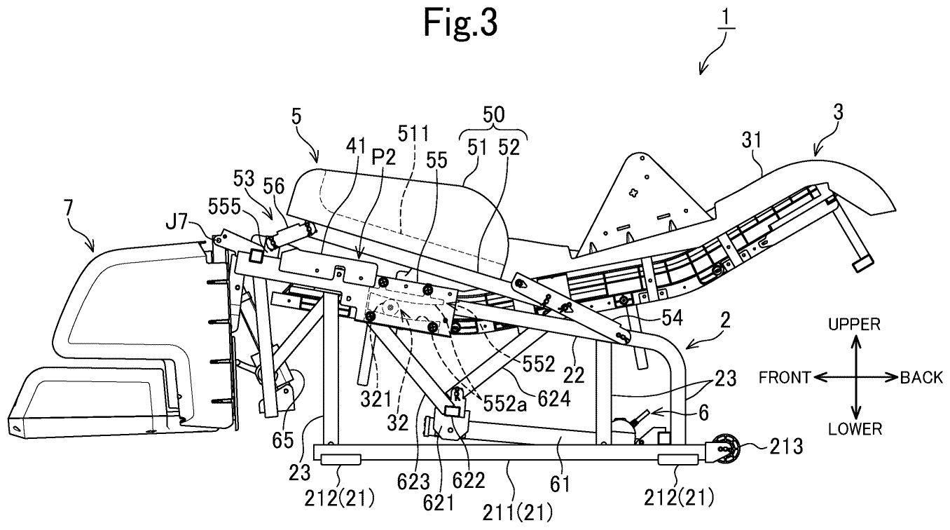

The seat 4 is a part provided with a cushion part that comes into contact with the buttocks and thighs of the user through an exterior member when he or she seated. A frame part 41, which is an illustrated part in the seat 4, supports the cushion member and is disposed so as to be movable in the front and back direction along the upper frame 22 of the base 2. The frame part 41 of this embodiment is stretched between the moving parts 55 arranged on the respective upper frames 22, and is thereby movable in the front and back direction. Therefore, the seat 4 moves in the front and back direction along the upper frames 22. More specifically, the seat 4 moves in the front and back direction along the upper frames 22 between a back end position P1 shown in FIG. 1 and a front end position P2 shown in FIG. 3. When the seat 4 is located at the front end position P2, a part (front end part) of the seat 4 is located forward of the front ends of the upper frames 22 (see a reference code β in FIG. 5).

The backrest 3 includes a backrest body 31 extending diagonally upward from the back end position of the seat 4, and reclining support shaft parts 32 protruding respectively from both ends of the backrest body 31 in the left and right direction. The backrest 3 is supported by the base 2 so as to be reclinable by engagement of the reclining support shaft parts 32 with the moving parts 55.

The backrest body 31 includes a pair of vertical frame parts 311 arranged in parallel or substantially parallel with each other with a gap therebetween in the left and right direction, and a horizontal frame part 312 connecting back ends of the vertical frame parts 311 (see FIG. 2). The pair of vertical frame parts 311 and the horizontal frame part 312 can be formed integral with each other. A treatment part is disposed between the pair of vertical frame parts 311 so as to be movable in the vertical direction along the vertical frame parts 311, although this is not shown in the Figures.

The reclining support shaft parts 32 protrude from both ends of the backrest body 31 in the left and right direction. In this embodiment, the reclining support shaft parts 32 protrude from the lower end part of the backrest body 31 and each have a roller 321. The roller 321 is disposed pivotally about its radial center.

The treatment part arranged between the vertical frame parts 311 of the backrest 3 includes treatment elements sometimes called “massage balls”. The treatment part generally includes a plurality of treatment elements (for example, two treatment elements spaced apart in the left and right direction), but is not limited to this and can have a single treatment element. Each of the treatment elements performs treatment on the user by moving with a pressing action, a kneading action, a tapping action, etc., against the body of the user.

As shown in FIG. 1 to FIG. 4, each of the armrest parts 5 includes an armrest 50 and a support mechanism 53 that supports the armrest 50.

The armrests 50 allow the user to place his or her arms thereon, or providing treatment on his or her arms thereon. Each of the armrests 50 includes an armrest body 51 and a third link (third member) 52 that supports the armrest body 51.

The armrest body 51 contacts with the arm of the user in the armrest 50. The armrest body 51 of this embodiment has a recess 511 that is open at the top and extends in the front and back direction. The arm of the user is placed in the recess 511. The armrest body 51 of this embodiment includes (e.g., incorporates) a treatment element that performs treatment to the arm to the user.

The armrest body 51 is provided with, for example, an airbag. The airbag is provided on the inner side of the side wall of the armrest body 51 to press the arm. More specifically, the airbag applies treatment (pressure) to the forearm (a portion from the elbow to the fingertips) on the outside of the arm. A plurality of airbags can be provided. The armrest body 51 can also include a treatment element such as a roller.

The third link 52 is a long member extending in the front and back direction, and is disposed below the armrest body 51. The third link 52 of this embodiment extends straight in the front and back direction, for example. Thereby, the third link 52 supports the armrest body 51 from below.

The support mechanism 53 supports the armrest 50 so that the armrest 50 moves with the reclining of the backrest 3. The support mechanism 53 of this embodiment, together with the armrest 50 (more specifically, the third link 52), forms a link mechanism. The support mechanism 53 includes a first link (first member) 54 connected to the back end portion of the armrest 50, a moving part 55 that moves along the upper frame 22 of the base 2, and a second link (second member) 56 connected to the front end portion of the armrest 50.

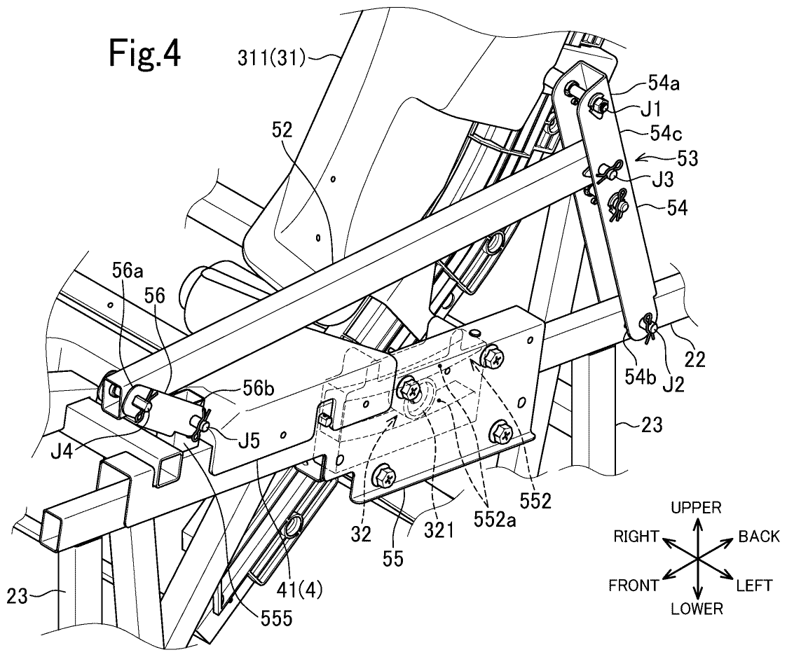

As shown in FIG. 4, the first link 54 is an elongated member that extends upward and forward when the backrest 3 is in the standing state. The first link 54 of this embodiment is, for example, an elongated straight member that extends straight upward and forward when the backrest 3 is in the standing state. One end portion (first end portion) 54a of the first link 54 is connected to the backrest 3 pivotally around a first shaft J1 extending in the left and right direction. The other end portion (second end portion) 54b of the first link 54 is connected to the base 2 pivotally around a second shaft J2 extending in the left and right direction. In the first link 54, a certain portion 54c between the first end portion 54a and the second end portion 54b is connected to the back end portion of the armrest 50 pivotally around a third shaft J3 extending in the left and right direction.

More specifically, the first end portion 54a of the first link 54 is connected to a portion of the backrest 3 located above the reclining support shaft part 32 and below the center of the backrest 3 in the vertical direction. The second end portion 54b of the first link 54 is connected to the back end portion of the upper frame 22. Further, the certain portion 54c of the first link 54 is a portion above the center of the first link 54 and is connected to the back end of the third link 52.

The moving part 55 moves in the front and back direction together with the seat 4 relative to the base 2. The moving part 55 of this embodiment moves in the front and back direction while being guided by the base 2 (more specifically, the upper frame 22). The moving part 55 has a plurality of rollers, and each of the rollers rotates while being in contact with the upper or lower surface of the upper frame 22, thereby allowing the moving part 55 to move smoothly in the front and back direction along the upper frame 22.

The moving part 55 also has a moving-part side engaging part 552 on the inside in the left and right direction (on the side of the user) that engages with the reclining support shaft part 32 of the backrest 3. The moving-part side engaging part 552 has a pair of guide surfaces 552a facing each other in the vertical direction, and the roller 321 of the reclining support shaft part 32 moves between the pair of guide surfaces 552a. In this embodiment, each guide surface 552a is curved so as to be convex downward.

The second link 56 is a long member that extends upward and forward when the backrest 3 is in the standing state. The second link 56 of this embodiment extends, for example, straight upward and forward when the backrest 3 is in the standing state. In this embodiment, the second link 56 is shorter than the first link 54. One end portion (third end portion) 56a of the second link 56 is connected to the front end portion of the armrest 50 pivotally around a fourth shaft J4 that extends in the left and right direction. The other end portion (fourth end portion) 56b is connected to the moving part 55 pivotally around a fifth shaft J5 that extends in the left and right direction.

More specifically, the third end portion 56a of the second link 56 is connected to a front end of the third link 52. Further, the fourth end portion 56b of the second link 56 is connected to a front end portion (more specifically, an upright portion extending upward from the front end portion) 555 of the moving part 55.

As shown in FIG. 1 to FIG. 3, the drive part 6 includes a first actuator (first drive source) 61 that drives the backrest 3, the seat 4, and the armrest parts 5, and a driving force transmission part 62 that transmits a driving force output from the first actuator 61. The drive part 6 further includes a second actuator (second drive source) 65 that drives the ottoman 7.

The first actuator 61 is a linear actuator that outputs a linear driving force. The direction in which the driving force is exerted is the front and back direction. The first actuator 61 of this embodiment is of an electrically driving type, although the drive method (drive principle) is not limited thereto. For example, the first actuator 61 can be of a hydraulically driving type. In order to follow the seat 4 moving in an oblique direction along the upper frame 22, the first actuator 61 is supported on the base 2 with its supporting angle variable. Specifically, the back end portion of the first actuator 61 is supported (axially supported) pivotally around a horizontal shaft, thereby enabling the first actuator 61 to perform an oscillating motion within a predetermined range in the vertical direction.

The driving force transmission part 62 includes an input part 621 that is connected to an output part from which the driving force is output in the first actuator 61, an intermediate transmission part 622 that transmits the driving force input to the input part 621 in the left and right direction, a pair of first arms 623 that are connected respectively to both end portions in the left and right direction of the intermediate transmission part 622 to transmit the driving force to the seat 4 through the moving parts 55, and a pair of second arms 624 that are connected to the intermediate transmission part 622 to transmit the driving force to the backrest 3 through the first links 54.

The first arms 623 extend upward and forward, have lower ends connected to the ends in the left and right direction of the intermediate transmission part 622, and have upper ends pivotally connected to the moving parts 55. The first arms 623 of this embodiment extend, for example straight upward and forward. The second arms 624 extend upward and backward, have lower end portions pivotally connected to the ends of the intermediate transmission part 622 (inward of the lower end portions of the first arms), and have upper end portions pivotally connected to the first links 54. The second arms 624 of this embodiment extend, for example, straight upward and backward. Each of the upper end portions of the second arms 624 is connected to the corresponding first link 54 at a portion between the connection portion to the third link 52 and the connection portion to the upper frame 22. Such a configuration that the first arms 623 are connected to the moving parts 55 and the upper end portions of the second arms 624 are connected to the first links 54 enables the driving force output from the first actuator 61 to be transmitted to the backrest 3 and the seat 4.

The second actuator 65 is an actuator for pivoting the ottoman 7. The second actuator 65 is disposed below the front end portion of the seat 4 and is connected to the ottoman 7 and the base 2. The second actuator 65 of this embodiment is of an electrically driving type, although the drive method (drive principle) is not limited thereto. For example, the second actuator 65 can be of a hydraulically driving type.

The ottoman 7 is supported on the front end portion of the seat 4 and provides a space for at least the lower legs of the user. The ottoman 7 of this embodiment has a wall part 71 that is disposed behind the calves of the user to come into contact with the calves (see FIG. 2). The ottoman 7 is pivotable between a standing position (the position shown in FIG. 1 and FIG. 3) in which the wall part 71 stands upright, and an extended position in which the ottoman 7 pivots around a rotation shaft J7 extending in the left and right direction (pivots clockwise in FIG. 1) such that a lower end of the wall part 71 extends further forward than in the standing position. In the massage machine 1 of this embodiment, the upper end portion of the wall part 71 of the ottoman 7 is connected to the front end portion of the seat 4 through the rotation shaft J7.

Next, the description will be made for the movements of the components which are linked with the reclining (movement) of the backrest 3 in the massage machine 1 configured as above, when the backrest 3 is reclined.

When the backrest 3 is reclined from the standing state (see FIG. 1 and FIG. 2), the first actuator 61 drives, so that the driving force output from the first actuator 61 is transmitted to the backrest 3 and the seat 4 via the driving force transmission part 62.

Specifically, when the driving force has been input from the first actuator 61 to the input part 621 of the driving force transmission part 62, and thereby the driving force has been transmitted to the first arms 623, the first arms 623 transmit the driving force to the moving parts 55. Thereby, each of the moving parts 55 moves forward along the upper frame 22. Since the seat 4 (more specifically, the frame part 41) is connected to the moving parts 55, the seat 4 also moves forward along the upper frames 22 with the movement of the moving parts 55. That is, the seat 4 moves along the upper frames 22 from the back end position P1 to the front end position P2.

On the other hand, when the driving force is transmitted to the second arms 624, the second arms 624 transmit the driving force to the first links 54. Thereby, the first links 54 pivot around the second shafts J2 so that the first end portions 54a move forward. Since the reclining support shaft parts 32 of the backrest 3 are engaged with the moving parts 55, the center of rotation for the reclining of the backrest 3 also moves forward together with the moving parts 55 (see FIG. 1 and FIG. 3).

Thereby, the backrest 3 is reclined and the seat 4 moves forward while the movements of the backrest 3 and the seat 4 are linked with each other.

Further, when the backrest 3 is reclined, the armrests 50 also move in linkage with the movements of the backrest 3 and the seat 4. Specifically, as shown in FIG. 5, the support mechanism 53 lowers the back end portion of each of the armrests 50 using the first link 54. At the same time, the support mechanism 53 moves the front end portion of each of the armrests 50 backward relative to the seat 4 using the moving part 55 and the second link 56. In FIG. 5, the upper view shows the positions of the armrest 50 and the support mechanism 53 when the backrest 3 is in the standing state (the state shown in FIG. 1), and the lower view shows the positions of the armrest 50 and the support mechanism 53 when the backrest 3 is in the reclined state (the state shown in FIG. 3).

More specifically, each of the first links 54, to which the driving force is transmitted through the second arm 624, pivots around the second shaft J2 so as to move the first end portion 54a forward, causing the back end portion of the armrest 50 (more specifically, the back end portion of the third link 52) to move in an arc. Thereby, the back end portion of the armrest 50 moves in an arc shape to be convex upwardly. That is, the back end portion of the armrest 50 moves forward relative to the base 2 while descending relative to the base 2.

Further, when the moving part 55 to which the driving force has been transmitted through the first arm 623 moves forward along the upper frame 22, the fifth shaft J5 moves forward together with the moving part 55. Thereby, the second link 56 pivots around the fifth shaft J5 so as to move the third end portion 56a backward, so that the front end portion of the armrest 50 (more specifically, the front end portion of the third link 52) moves in an arc. Thereby, the front end portion of the armrest 50 moves in an arc shape to be convex upwardly. That is, the front end portion of the armrest 50 moves forward relative to the base 2, moves up once, and then moves down relative to the base 2.

When the backrest 3 is in the reclined state, the front end portion of the armrest 50 moves up to a position higher than the position when the backrest 3 is in the standing state in response to the forward movement of the moving part 55 along the upper frame 22 (h11<h12 in FIG. 5). At this time, the back end portion of the armrest 50 moves down to a position lower than the position when the backrest 3 is in the standing state (h21>h22 in FIG. 5).

A forward movement distance α1 of the front end portion of the armrest 50 relative to the base 2 (installation surface) at the time of reclining of the backrest 3 becomes smaller than a forward movement distance α2 of the seat 4 (moving part 55) relative to the base 2 (installation surface) by pivoting of the second link 56 around the fifth shaft J5 so as to cause the third end portion 56a to move backward (see FIG. 5). Thereby, the armrest 50 moves backward relative to the seat 4 with the reclining of the backrest 3. In FIG. 5, since the movement distances in the front and back direction of the seat 4 and the moving part 55 are the same as each other, the dimension line indicating the movement distance α2 is placed at the leading end of the moving part 55.

Next, when the backrest 3 rises up from the reclined state (see FIG. 3), the first actuator 61 is driven (moves in the opposite direction to the moving direction when the backrest 3 is reclined), and the driving force output from the first actuator 61 is transmitted to the backrest 3 and the seat 4 through the driving force transmission part 62.

Specifically, when the driving force has been input from the first actuator 61 to the input part 621 of the driving force transmission part 62, and thereby the driving force has been transmitted to the first arms 623, the first arms 623 transmit the driving force to the moving parts 55. Thereby, the moving parts 55 move backward along the upper frames 22. Since the seat 4 is connected to the moving parts 55 (more specifically, to the frame part 41), the seat 4 moves backward along the upper frames 22 with the movement of the moving parts 55. That is, the seat 4 moves along the upper frames 22 from the front end position P2 to the back end position P1.

On the other hand, when the driving force is transmitted to the second arms 624, the second arms 624 transmit the driving force to the first links 54. Thereby, each of the first links 54 pivots around the second shaft J2 so as to move the first end portion 54a backward. Since each of the reclining support shaft parts 32 of the backrest 3 is engaged with the moving part 55, the center of rotation for the reclining of the backrest 3 moves backward together with the moving part 55 (see FIG. 3 and FIG. 1).

Thereby, in the massage machine of this embodiment, the backrest 3 rises up and the seat 4 moves backward in the state where the movements of the backrest 3 and the seat 4 are linked with each other.

Further, when the backrest 3 rises up, each of the armrest 50 moves in linkage with the movements of the backrest 3 and the seat 4. Specifically, the support mechanism 53 moves upward the back end portion of the armrest 50 by the first link 54 and moves the front end portion of the armrest 50 forward relative to the seat 4 by the moving part 55 and the second link 56.

More specifically, the first link 54, to which the driving force has been transmitted through the first arm 623, pivots around the second shaft J2 so as to move the first end portion 54a backward. In this manner, the back end portion of the armrest 50 (more specifically, the back end portion of the third link 52) moves in an arc. Thereby, the back end portion of the armrest 50 moves up once and then moves down relative to the base 2, while moving backward relative to the base 2.

Further, the moving part 55, to which the driving force has been transmitted through the second arm 624, moves backward along the upper frame 22, causing the second link 56 to pivot around the fifth shaft J5 so as to move the third end portion 56a forward. In this manner, the front end portion of the armrest 50 (more specifically, the front end portion of the third link 52) moves in an arc. Thereby, the front end portion of the armrest 50 moves in an arc shape to be convex upwardly. That is, the front end portion of the armrest 50 moves down relative to the base 2 while moving backward relative to the base 2.

When the backrest 3 is in the standing state, the front end portion of the armrest 50 moves down to a position lower than the position when the backrest 3 is in the reclined state (h12>h11 in FIG. 5), and the back end portion of the armrest 50 moves up to a position higher than the position when the backrest 3 is in the reclined state (h22<h21 in FIG. 5).

When the backrest 3 rises up, the distance α1 by which the front end portion of the armrest 50 moves backward relative to the base 2 is smaller than the distance α2 by which the seat 4 (moving part 55) moves backward relative to the base 2 (installation surface) (see FIG. 5). Thereby, the armrest 50 moves forward relative to the seat 4 with the rising up of the backrest 3.

The massage machine 1 includes a base 2; a backrest 3 supported by the base 2 so as to be reclined relative to the base; a seat 4 that moves forward relative to the base 2 with the reclining of the backrest 3; an armrest 50; and a support mechanism 53 that supports the armrest 50 so as to allow the armrest 50 to move with the relining of the backrest 3. The support mechanism 53 is configured to lower a back end portion of the armrest 50 and move a front end portion of the armrest 50 backward relative to the seat 4 when the backrest 3 is reclined.

According to this configuration, the armrest 50 can be moved with the reclining of the backrest 3 by the support mechanism 53 having a simple configuration.

Further, in the massage machine 1 of this embodiment, the support mechanism 53 includes a first link (first member) 54 connected to the back end portion of the armrest 50 and the backrest 3; a moving part 55 that moves back and forth relative to the base 2 together with the seat 4; and a second link (second member) 56 connected to the front end portion of the armrest 50 and the moving part 55, in which when the backrest 3 is reclined, the back end portion of the armrest 50 is lowered by the first link 54, and the front end portion of the armrest 50 is moved backward relative to the seat 4 by the moving part 55 and the second link 56. This allows the support mechanism 53 to be further simplified.

Further, in the massage machine 1 of this embodiment, the support mechanism 53 is configured to move the front end portion of the armrest 50 forward relative to the base 2 with the relining of the backrest 3. A distance α1 by which the front end portion of the armrest 50 moves forward relative to the base 2 is smaller than a distance α2 by which the seat 4 moves forward relative to the base 2 when the backrest 3 is reclined.

In this way, by restricting the forward movement distance α1 of the armrest 50 relative to the forward movement distance α2 of the seat 4 when the backrest 3 is reclined, the armrest 50 moves backward relative to the seat 4. This makes it possible to suppress changes in the positional relationship between the armrest 50 and an arm of a user when the user changes his or her posture by reclining the backrest 3.

In the massage machine 1 of this embodiment, the armrest 50 and the support mechanism 53 form a link mechanism. In this way, by using the link mechanism to move the armrest 50 with the reclining of the backrest 3, the configuration of the support mechanism 53 can be made simpler.

In the massage machine 1 of this embodiment, the second link (second member) is connected to the moving part 55 pivotally around the fifth shaft (axis) J5 extending in the left and right direction, and when the moving part 55 moves forward together with the seat 4 relative to the base 2, the front end portion of the armrest 50 pivots relative to the moving part 55 so as to move backward relative to the moving part 55.

By pivoting of the link (second link) 56 that constitutes the link mechanism in this manner, the forward movement distance α1 of the front end portion of the armrest 50 relative to the base 2 is reduced compared to the forward movement distance α2 of the seat 4 relative to the base 2 when the backrest 3 is reclined. This effectively prevents changes in the positional relationship between the armrest 50 and the arm of the user when the user changes his or her posture by reclining the backrest 3.

In the massage machine 1 of this embodiment, the first link (first member) 54 is a long member. The first link 54 includes: the first end portion (one end portion) 54a connected to the backrest 3 pivotally around the first shaft (shaft) J1 extending in the left and right direction, the second end portion (the other end portion) 54b is connected to the base 2 pivotally around the second shaft (shaft) J2 extending in the left and right direction, and the certain portion 54c between the first end portion 54a and the second end portion 54b is connected to the back end portion of the armrest 50 pivotally around the third shaft (shaft) J3 extending in the left and right direction. In this way, the link (first link) 54 that forms the link mechanism is connected to the armrest 50, the backrest 3, and the base 2, so that the reclining of the backrest 3 relative to the base 2 and the movement of the armrest 50 can be linked with each other. The expression “connect” in this embodiment is intended to encompass a form in which connection is made through a certain member.

In the massage machine 1 of this embodiment, the moving part 55 is guided by the base 2. According to such a configuration that the moving part 55 is guided using a part of the base 2 (in this embodiment, the upper frame 22), it is not necessary to provide a separate member for guiding the moving part 55, thereby further simplifying the configuration of the support mechanism 53.

The massage machine of the present disclosure is not limited to the above-described embodiment, and various modifications can be made within departing the scope of the present disclosure. For example, the configuration of one embodiment can be added to the configuration of another embodiment, and part of the configuration of one embodiment can be replaced with the configuration of another embodiment. Further, some of the configurations of an embodiment can be omitted.

Although the support mechanism 53 of the above embodiment forms the link mechanism together with the armrest 50 (third link 52), the present disclosure is not limited to this configuration. The mechanism for moving the armrest 50 with the reclining of the backrest 3 can be configured by a mechanism other than the link mechanism. For example, the support mechanism 53 can include a cam, a gear, a chain belt, or the like so as to move the armrest 50 with the reclining of the backrest 3. Further, a part of the components forming the support mechanism 53 can be replaced with another component such as a cam, a gear, or a chain belt.

Further, the support mechanism 53 of the above embodiment is configured to move the front end portion of the armrest 50 forward relative to the base 2 (installation surface) with the reclining of the backrest 3, but is not limited to this configuration. The support mechanism 53 can be configured to move the front end portion of the armrest 50 backward relative to the base 2 with the reclining of the backrest 3, or configured to maintain its position. That is, the support mechanism 53 can be configured to move the front end portion of the armrest 50 backward relative to the seat 4 with the reclining of the backrest 3.

Further, the armrest body 51 in the above embodiment includes the treatment element. That is, the armrest body 51 has a massage function, but is not limited to this configuration. The armrest body 51 can be a simple armrest that does not include the treatment element, i.e., does not have a massage function.

Further, the armrest body 51 of the above embodiment has the recess 511 that is open at the top and extends in the front and back direction, but is not limited to this configuration. The armrest body 51 can, for example, have a recess that opens on the inner side in the left and right direction (on the side of the user when seated) and extends in the front and back direction (i.e., a configuration for inserting the arm from the inner side in the left and right direction), or it can be merely a support body (a support body on which the arm is placed and which does not cover the arm placed on it), or it can be a configuration that covers only a part of the arm (for example, the fingertip portion), or it can be a configuration that covers the arm from all directions.

Further, in the above embodiment, the armrest body 51 is fixed to the third link 52 so as not to be removed, but the configuration is not limited thereto. The armrest body 51 can be removably fixed to the third link 52.

The massage machine of this embodiment is as described above, but the present disclosure is not limited to the above embodiment, and the design can be appropriately modified within the intended scope of the present disclosure. Further, the effects of the present disclosure are not limited to the above-described embodiments. That is, the presently disclosed mode of implementation should be considered exemplary in all respects and not restrictive. The scope of the present disclosure is shown not by the above description but by the scope of the claims. It is also intended that the scope of the present disclosure include all changes within the same meaning and scope as the claims.

What is claimed is:

1. A massage machine comprising:
a base;
a backrest supported by the base so as to be reclined relative to the base;
a seat that moves forward relative to the base with the reclining of the backrest;
an armrest; and
a support mechanism that supports the armrest so as to allow the armrest to move with the reclining of the backrest,
the support mechanism being configured to lower a back end portion of the armrest and move a front end portion of the armrest backward relative to the seat when the backrest is reclined.

2. The massage machine according to claim 1, wherein the support mechanism is configured to move the front end portion of the armrest forward relative to the base with the reclining of the backrest, and a distance by which the front end portion of the armrest moves forward relative to the base is smaller than a distance by which the seat moves forward relative to the base when the backrest is reclined.

3. The massage machine according to claim 1, wherein the support mechanism comprises:
a first member connected to the back end portion of the armrest and the backrest;
a moving part that moves back and forth relative to the base together with the seat;
a second member connected to the front end portion of the armrest and the moving part, wherein
when the backrest is reclined, the back end portion of the armrest is lowered by the first member, and the front end portion of the armrest is moved backward relative to the seat by the moving part and the second link.

4. The massage machine according to claim 3, wherein the armrest and the support mechanism form a link mechanism.

5. The massage machine according to claim 4, wherein the second member is connected to the moving part pivotally around a shaft extending in a left and right direction, and
when the moving part moves forward together with the seat relative to the base, the front end portion of the armrest pivots relative to the moving part so as to move backward relative to the moving part.

6. The massage machine according to claim 4, wherein the first member is a long member, the first member comprising:
one end portion connected to the backrest pivotally around a shaft extending in the left and right direction;
another end portion connected to the base pivotally around a shaft extending in the left and right direction; and
a certain portion between the one end portion and the opposite end portion being connected to the back end portion of the armrest pivotally around a shaft extending in the left and right direction.

7. The massage machine according to claim 3, wherein the moving part is guided by the base.
